(19) United States
(12) Patent Application Publication
(10) Pub. No.: US 2025/0333823 A1
(43) Pub. Date: Oct. 30, 2025

(54) SOFT MAGNETIC ALLOY PARTICLE, SOFT MAGNETIC POWDER, DUST CORE, AND ELECTRONIC COMPONENT

(71) Applicant: TDK Corporation, Tokyo (JP)

(72) Inventors: Satoko MORI, Tokyo (JP); Kazuhiro YOSHIDOME, Tokyo (JP); Hiroyuki MATSUMOTO, Tokyo (JP)

(73) Assignee: TDK Corporation, Tokyo (JP)

(21) Appl. No.: 19/189,563

(22) Filed: Apr. 25, 2025

(30) Foreign Application Priority Data
Apr. 26, 2024 (JP) 2024-072693

(51) Int. Cl. C22C 38/02; B22F 1/05; B22F 1/142; B22F 3/02; B22F 3/24; B22F 9/08; C22C 38/10; H01F 1/147; H01F 3/08

(52) U.S. Cl. CPC C22C 38/02; B22F 1/05; B22F 1/142; B22F 3/02; B22F 3/24; B22F 9/082; C22C 38/10; H01F 1/14766; B22F 2003/248; B22F 2009/0848; B22F 2201/10; B22F 2301/35; B22F 2304/10; B22F 2998/10; B22F 2999/00; C22C 2202/02; H01F 3/08

(57) ABSTRACT

A soft magnetic alloy particle including Fe and Si. One to twenty nitride phases are observed in a cross-section of the soft magnetic alloy particle, an area per each of the nitride phases is within a range of 0.0005 to 10 μm², and an area ratio of the observed nitride phases occupying the cross-section of the soft magnetic alloy particle is within a range of 0.1 to 2%.

### TECHNICAL FIELD

The present disclosure relates to a soft magnetic alloy particle, a soft magnetic alloy powder, a dust core, and an electronic component.

### BACKGROUND

In recent years, there has been a demand for low power consumption and high efficiency in electronic, information, and communication devices. Such demand has become even stronger to achieve a low-carbon society. Thus, there has been a demand for reduced energy loss and enhanced power efficiency also for a power circuit used for the electronic, information, and communication devices. When a crystalline soft magnetic powder having a high saturation magnetic flux density is used as a material of a magnetic core of an electronic component such as a magnetic element, reduction in coercivity is important.

### PRIOR ART DOCUMENT

### Patent Document

Patent Document 1: JP Patent Application Laid Open No. 2023-24289

### SUMMARY

The present disclosure is achieved in view of such circumstances, and the object is to provide a soft magnetic alloy particle included in a soft magnetic powder of which an increase of coercivity is small even after pressure is applied and also capable of reducing core loss. Further, the object of the present disclosure is also to provide a soft magnetic powder, a dust core, and an electronic component including the particle.

### Means for Solving the Objects

In order to achieve such object, the soft magnetic alloy particle according to an embodiment of the present disclosure includes Fe and Si:
wherein one to twenty nitride phases are observed in a cross-section of the soft magnetic alloy particle,
an area per each of the nitride phases is within a range of 0.0005 to 10 μm², and
an area ratio of the observed nitride phases occupying the cross-section of the soft magnetic alloy particle is within a range of 0.1 to 2%.

In the case that the soft magnetic powder including the above-mentioned soft magnetic alloy particle is pressurized to mold into a predetermined shape, it is possible to lower an increase rate of coercivity after pressure molding compared to a coercivity of a powder of before pressure molding. For the soft magnetic powder including the soft magnetic alloy particle containing a nitride phase, stress caused by pressure molding is relieved due to the presence of the nitride phase, and it is thought that the increase of the coercivity can be prevented. Also, due to the presence of the nitride phase, eddy current is suppressed, and core loss which includes eddy current loss can be lowered. It is thought that the reason for this is because the powder resistance has improved due to the presence of the nitride phase.

A particle size of the soft magnetic alloy particle may preferably be 4 μm or larger. In a cross-section of the soft magnetic alloy particle, a number ratio of the nitride phases existing within an area of 2 μm from a surface or a crystalline grain boundary of the soft magnetic alloy particle is preferably 45% or more and 95% or less, more preferably 50% or more and 95% or less, or 80% or more and 90% or less with respect to the entire nitride phases. By configuring as such, the increase rate of coercivity after pressure molding can be further lowered.

The composition of the soft magnetic alloy particle is not particularly limited as long as it is the soft magnetic alloy particle including Fe and Si. The soft magnetic alloy particle may further include Co. By configuring as such, the increase rate of coercivity after pressure molding can be further lowered.

The nitride phase preferably includes 20 atom % or more, or 30 atom % or more of nitrogen. The nitride phase may include silicon in addition to nitrogen.

The soft magnetic powder according to an embodiment of the present disclosure includes the above-mentioned soft magnetic alloy particle. The soft magnetic powder according to an embodiment of the present disclosure may include a soft magnetic particle in addition to the above-mentioned soft magnetic alloy particle. Preferably, in the soft magnetic powder, 1 to 20 nitride phases within a size of 0.0005 to 10 μm² are observed per one particle in average which is calculated from a predetermined number of particles randomly selected under a predetermined condition; and an area ratio of the nitride phases occupying the observed particle is within a range of 0.1 to 2%.

The soft magnetic powder according to another embodiment of the present disclosure includes:
soft magnetic alloy particles including Fe and Si,
wherein one to twenty nitride phases per each of the soft magnetic alloy particles in average are observed in cross-sections of the soft magnetic alloy particles,
an area per each of the nitride phases is within a range of 0.0005 to 10 μm² in average, and
an area ratio of the observed nitride phases occupying the cross-section of each of the soft magnetic alloy particles is within a range of 0.1 to 2% in average.

In the case of applying pressure to the soft magnetic powder satisfying such configurations in order to mold into a predetermined shape, the increase rate of coercivity of after the pressure molding can be lowered compared to the coercivity of the powder of before pressure molding. Regarding the soft magnetic powder including the soft magnetic alloy particle containing the nitride phase, stress caused by pressure molding is relieved due to the presence of the nitride phase, and it is thought that the increase of the coercivity can be prevented. Also, due to the presence of the nitride phase, eddy current is suppressed, and also eddy current loss can be lowered. It is thought that the reason for this is because the powder resistance has improved due to the presence of the nitride phase.

A dust core according to an embodiment of the present disclosure includes the above-mentioned soft magnetic alloy particles.

An electronic component according to an embodiment of the present disclosure includes the above-mentioned soft magnetic alloy particles.

### BRIEF DESCRIPTION OF DRAWINGS

FIG. 1 is a SEM image of a soft magnetic alloy particle according to an embodiment of the present disclosure.

FIG. 2 is a Fe mapping image of the soft magnetic alloy particle shown in FIG. 1.

FIG. 3 is a N mapping image of the soft magnetic alloy particle shown in FIG. 1.

FIG. 4 is a Si mapping image of the soft magnetic alloy particle shown in FIG. 1.

### DETAILED DESCRIPTION

In below, embodiments of the present disclosure are described.

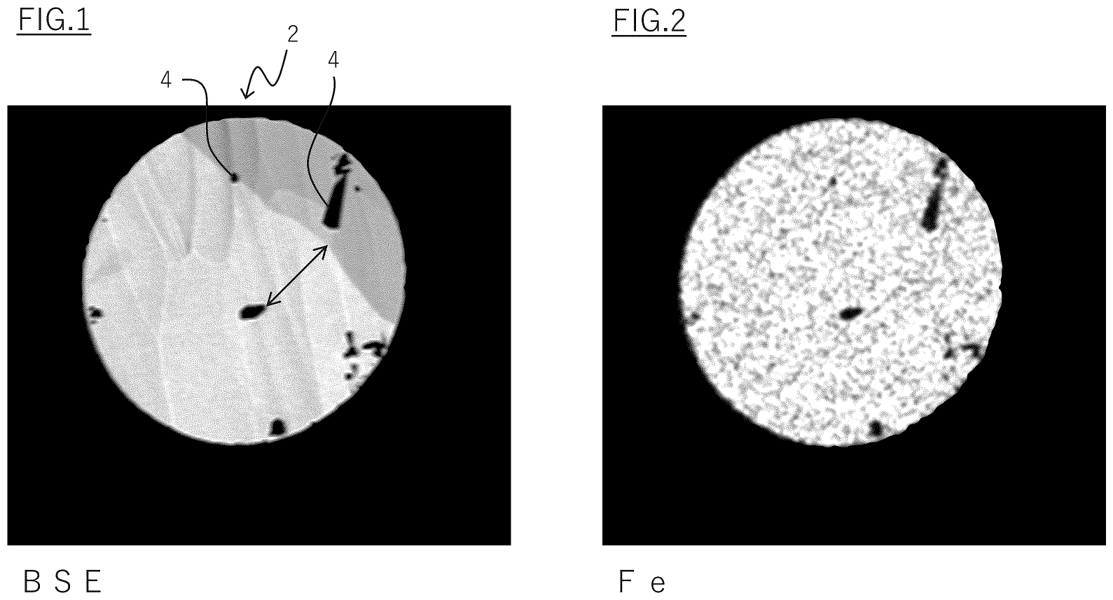

A soft magnetic alloy powder according to the present embodiment, for example, includes many soft magnetic alloy particles 2 shown in FIG. 1. The particle 2 shown in FIG. 1 is configured of a single crystallite or a plurality of crystallites. An average particle size of the particles 2 is not particularly limited, and for example, it may be 1 μm or larger and 50 μm or smaller, or may be 4 μm or larger. Also, an average crystallite size of the crystallites is not particularly limited, and for example, it may 0.5 μm or larger and 20 μm or smaller.

By observing a backscattered electron image using SEM, it is possible to verify that the soft magnetic alloy particle 2 includes the crystallite. A magnification of the backscattered electron image is not particularly limited, and it may be any magnification and resolution as long as the above-mentioned fine structure of the soft magnetic alloy particle can be verified. For example, the magnification may be 500 times or greater and 10000 times or less.

The soft magnetic alloy particle 2 at least includes Fe and Si, and as other elements, for example, Co, Al, Cr, C, S, Ti, V, Mn, Ni, and Cu may be included. For example, a content of Si included in the soft magnetic alloy particle 2 may be 1 to 15 atom %. Also, Fe may be substituted by Co and Ni. A total of Fe+Co+Ni included in the soft magnetic alloy particle 2 may be 80 to 100 atom %. Further, Al may be included in the soft magnetic alloy particle 2 in a ratio of 0 to 10 atom %.

Further, other additional elements may be included within a range which does not significantly influence properties of the soft magnetic powder and so on including the soft magnetic alloy particles 2. For example, the additional elements may be respectively included by 5 mass % or less, or 1 mass % or less. Also, a total content of the additional elements may be 10 mass % or less, or 2 mass % or less.

Also, the soft magnetic alloy particle 2 may only include Fe, Si, and inevitable impurities. In this case, a content of the inevitable impurities may be 2 mass % or less, or 1 mass % or less.

As shown in FIG. 1, preferably one or more of nitride phases 4 may be observed in a cross-section of the particle 2. An area of one nitride phase 4 is preferably within a range of 0.0005 to 10 μm² in average, and more preferably 0.0005 to 5 μm² in average which is obtained from randomly selected samples of 100 or more of the particles 2 included in the powder.

Similarly, by randomly selecting the particles 2, preferably 1 to 20 nitride phases, more preferably 4 to 20 nitride phases are observed in average in the cross-section of the particle 2. Similarly, by randomly selecting the particles 2, an area ratio of the observed nitride phases 4 occupying the cross-section of the particle 2 is preferably within a range of 0.1 to 2%, or more preferably within a range of 0.4 to 2%.

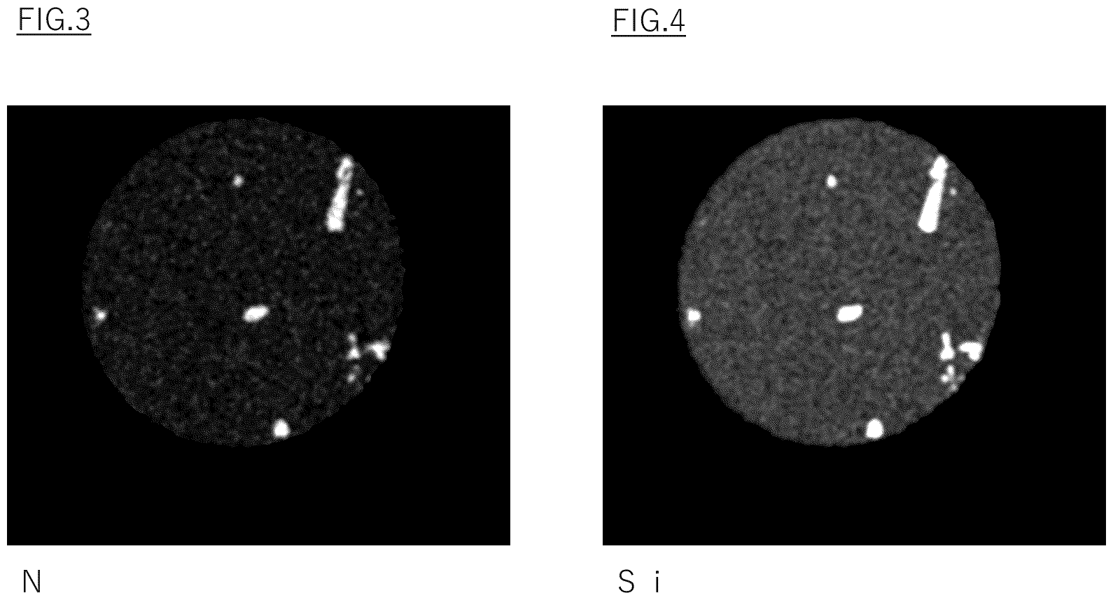

As shown in FIG. 3 and FIG. 4, for example in the mapping image of SEM, the nitride phase 4 preferably at least includes silicon (Si) in addition to nitrogen (N), and preferably Fe is substantially not included in the nitride phase 4 as shown in FIG. 2. In electron diffraction of a transmission electron microscope, the nitride phase may include a crystal having a diffraction pattern which can be indexed by Si₃N₄.

A ratio of N in the nitride phase 4 is preferably 20 atom % or more, 30 atom % or more, or 40 atom % or more. A ratio of Si in the nitride phase 4 is preferably 10 atom % or more, or 50 atom % or more when a total of elements excluding nitrogen in the nitride phase 4 is 100 atom %. Also, a content of Fe in the nitride phase 4 is preferably 20 atom % or less.

In the nitride phase 4, an element configuring the soft magnetic particle may be included, examples of such element include Co, Cr, Al, C, and S; and a total of such element is 50 atom % or less. Analysis and measurements of these elements can be done using EPMA, SEM-EDX, STEM-EDX, and the like.

As shown in FIG. 1, the nitride phases 4 are more observed near the crystal grain boundary or near the surface of the soft magnetic alloy particle 2. A particle size is not particularly limited, and the particle size of the soft magnetic alloy particle 2 is preferably 1 μm or larger, or 4 μm or larger. In the cross-section of the soft magnetic alloy particle 2, a number ratio of nitride phases existing within an area of 2 μm from the surface of the soft magnetic alloy particle 2 or crystal grain boundary of the soft magnetic alloy particle 2 is preferably 45% or more and 95% or less, more preferably 50% or more and 95% or less, or 80% or more and 90% or less with respect to the entire nitride phases. By configuring as such, the increase rate of coercivity after pressure molding can be further lowered. When a shortest distance from the surface or the crystal grain boundary to the nitride phase is 2 μm or less as it is indicated by an arrow shown in FIG. 1, then it is possible to confirm that the nitride phase exists within an area of 2 μm from the surface of the soft magnetic alloy particle 2 or the crystal grain boundary.

In the soft magnetic powder according to the present embodiment, other soft magnetic powders may be included. Such other soft magnetic powders may be a soft magnetic powder with different average particle size, or it may be a soft magnetic powder having different compositions from the above-mentioned soft magnetic powder. Such other soft magnetic powders may be configured only using the soft magnetic particles not containing the above-mentioned nitride phases. In the soft magnetic alloy powder of the present embodiment, the soft magnetic alloy particles in the soft magnetic powder having the above-mentioned configurations are preferably 20 mass % or more, more preferably 80 mass % or more.

Note that, “the soft magnetic alloy particle in the soft magnetic powder having the above-mentioned configurations” is a particle in which one to twenty nitride phases 4 are observed in the cross-section of the particle 2, an area of one nitride phase 4 is within a range of 0.0005 to 10 μm², and an area ratio of the observed nitride phases occupying the cross-section of the soft magnetic alloy particle is within a range of 0.1 to 2%.

Regarding a dust core configured using the soft magnetic powder according to the present embodiment, in the cross-section where 200 or more magnetic particles are observed, preferably at least 10% or more of the soft magnetic alloy particles having the above-mentioned configurations are included in terms of a number ratio.

Also, at the surface of the soft magnetic alloy particle 2, an oxide coating may be formed. For example, a thickness of the oxide coating may be 5.0 nm or less, or 3.0 nm or less. The thinner the oxide coating, the easier it is to improve density of the dust core including the soft magnetic alloy particles 2.

In below, an example of a method for producing the soft magnetic powder including the soft magnetic alloy particle according to the present embodiment is described; however, the method for producing the soft magnetic powder according to present embodiment is not limited to the below described method. Note that, in the present embodiment, a substance including a plurality of particles is defined as a powder.

First, raw materials of the soft magnetic powder are prepared. The prepared raw materials may be simple metals, or may be alloys. A form of the raw materials is not particularly limited. For example, it may be an ingot, a chunk, or a shot.

Next, the prepared raw materials are weighed and mixed. At this time, the raw materials are weighed so as to obtain the soft magnetic powder having the target composition obtained at the end. Then, the mixed raw materials are melted and mixed to obtain a molten. Tools used for melting and mixing are not particularly limited. For example, a crucible is used.

Then, the soft magnetic powder is formed using the molten. A method for producing the soft magnetic powder using the molten is not particularly limited, and for example, a gas atomization method, a rotating disk method, a water atomization method can be used. Among these, in a gas atomization method, the molten is supplied as continuous liquid using a nozzle or so, and high-pressure gas is collided against the supplied molten and quenched. Thereby, the soft magnetic powder can be produced.

Next, the obtained soft magnetic powder is heat treated. By carrying out a heat treatment at this point under appropriate conditions, the soft magnetic powder including the soft magnetic alloy particles according to the present embodiment can be obtained.

The preferable heat treatment conditions may change depending on the composition of the target soft magnetic powder, and usually a holding temperature during the heat treatment is preferably 800° C. or higher and 1100° C. or lower, and more preferably 800° C. or higher and 1000° C. or lower. A holding time is preferably 10 minutes or longer and 6 hours or shorter, and more preferably 30 minutes or longer and 5 hours or shorter.

Further, a cooling rate until reaching 300° C. after the heat treatment is 0.1° C./s or faster and 10° C./s or slower. The heat treatment atmosphere is preferably under atmosphere including nitrogen gas, and inert gas such as argon may be included. Also, the atmosphere pressure during the heat treatment of the soft magnetic powder is preferably between 0.08 kPa and 0.45 kPa, or more preferably between 0.1 kPa and 0.45 kPa in terms of a gauge pressure. Note that, a gauge pressure refers to a pressure which subtracts atmospheric pressure from absolute pressure (pressure when absolute vacuum is 0 Pa).

Particularly, by keeping the holding temperature during the heat treatment at a high temperature and by increasing atmosphere pressure (the gauge pressure), the soft magnetic alloy particle 2 containing the nitride phase 4 having the above-mentioned configurations can be obtained.

According to the above-mentioned method, the soft magnetic powder including the soft magnetic alloy particle according to the present embodiment can be obtained. Also, a dust core can be obtained by using a usual method to the soft magnetic powder according to the present embodiment. A method for obtaining the dust core is not particularly limited.

The dust core may be obtained by using a soft magnetic powder which is obtained by mixing the soft magnetic powder according to the present embodiment and other soft magnetic metal powders. A type of other soft magnetic metal powders is not particularly limited. For example, a soft magnetic metal powder having a smaller average particle size than the soft magnetic powder according to the present embodiment may be used. An average particle size of the soft magnetic metal powder having the smaller average particle size as mentioned in above may be 0.5 μm or larger and 5 μm or smaller. A material of the soft magnetic metal powder having the smaller average particle size as mentioned in above is not particularly limited. For example, metals such as pure iron, alloys such as permalloy, etc., may be used.

In the case of mixing the soft magnetic powder according to the present embodiment and the soft magnetic metal powder having the smaller average particle size as mentioned in above, a ratio of the soft magnetic powder is not particularly limited. For example, the ratio of the soft magnetic powder according to the present embodiment may be 50 mass % or more.

Regarding the dust core according to the present embodiment, the coercivity is suppressed to relatively small value, and a coil component such as an inductor, a reactor, and a motor can be obtained using a usually used method. Particularly, according to the present embodiment, a coil component achieving high saturation current, low coil resistance, high frequency, and low loss can be obtained. Further, in the case of using the dust core according to the present embodiment, the coil component can be easily downsized. A method for obtaining the coil component is not particularly limited.

### EXAMPLES

In below, the present disclosure is explained in further detail using examples and comparative examples; however, the present disclosure is not limited to the below described examples.

### Sample Nos. 1 to 9

### [Production of Soft Magnetic Powder]

First, an ingot, a chunk, or a shot of simple Fe and simple Si were prepared. Then, the simple Fe and the simple Si were mixed so that a content of Si was as shown in Table 1. Then, a mixture of the simple Fe and the simple Si was placed in a crucible arranged in a gas atomization apparatus. Next, in inert atmosphere, using a work coil provided to the outside of the crucible, the crucible was heat to 1500° C. or higher using high frequency induction to melt and mix the ingot, chunk, or shot in the crucible; thereby, a molten was obtained.

Next, upon supplying the molten inside the crucible from a nozzle provided to the crucible, a gas of 1 to 10 M Pa was collided against the supplied molten for quenching; thereby, Fe—Si based soft magnetic alloy powders having compositions shown in Table 1 and Table 2 were produced. Note that, in all of the soft magnetic powders, the average particle size of the soft magnetic alloy particles was adjusted to 25 μm.

Further, the obtained soft magnetic powder was heat treated. H eat treatment conditions of each sample were as shown in Table 1. Note that, a cooling rate from a holding temperature of the heat treatment to 300° C. was 1° C./sec for all cases, and the pressure indicated in Table 1 was a gauge pressure.

### [Evaluation of Soft Magnetic Powder]

### (Evaluation of Magnetic Properties)

A coercivity Hc of the heat treated soft magnetic powder was measured. The coercivity was measured using a Hc meter, and the results are shown in Table 1. In the table, the coercivity of the powder which had not been pressurized is indicated as Hc1, and the coercivity of the powder after being pressurized for one minute at 8 t/cm², and then crushed is indicated as Hc2. The smaller the H cl, the more preferable it is; and particularly in Tables 1 to 3, preferably H cl was less than 5.0 Oe. The smaller the Hc2, the more preferable it is; and particularly in Tables 1 to 3, preferably Hc2 was less than 10.0 Oe. Also, for each sample, Table 1 shows a proportion Hc2/Hc1 which represent a proportion of the coercivity Hc2 of after being pressurized with respect to the coercivity Hc1 of before pressurizing. The smaller the proportion Hc2/Hc1, the more preferable it is, and preferably it is 2.1 or less.

### (Observation of Nitride Phase)

A resin was kneaded with the obtained soft magnetic powder, and then cured to obtain a compound. Then, a cross section of the compound which was obtained by cross-section polishing was observed. Specifically, the soft magnetic powder and a thermosetting epoxy resin were mixed and formed into a sheet form having a thickness of about 300 μm, and then it was cured at 120° C. Then, the cross-section polishing was carried out using an Ar ion milling apparatus (IM-4000 made by Hitachi High-Tech). Then, using SEM (SU5000 made by Hitachi High-Tech), the cross section was observed at an acceleration voltage of 5 kV.

For example, as shown in FIG. 1, the nitride phase 4 was observed as a dark contrast in the backscattered electron image. Also, by analyzing an EDX (E-max made by HORIBA) attached to SEM, a composition of a segregation phase (nitride phase) can be identified. The EDX analysis was carried out by measuring at an acceleration voltage of 10 kV. Also, by observing the compound using a backscattered electron detector attached to SEM under a magnification of 2000 times, it was confirmed that the soft magnetic alloy particles contained in the soft magnetic powder included the crystallites from the backscattered electron image obtained.

Similarly, regarding the dust core, the cross-section polishing was performed using an Ar ion milling apparatus, and a backscattered electron image of SEM was observed, then EDX analysis was carried out. Thereby, the nitride phase was identified.

Also, 100 particles were randomly selected from the cross-section image of the soft magnetic alloy particles of the soft magnetic powder to measure an average of the cross-section areas (an average cross-section area) of the nitride phases 4, an average number of nitride phases per one particle, and an average area ratio per one particle were measured. The results are shown in Table 1. Note that, a nitride phase having a cross-section area of less than 0.0005 μm² was not counted, also it was not included for the measurements of the cross-area and the area ratio.

TABLE 1

| | | | | Heat treatment | | | | Nitride phase | | | | | |
|---|---|---|---|---|---|---|---|---|---|---|---|---|---|
| | | | Ave. | Temp. | | | | | Ave. cross- | Number | | | |
| | | | particle | rising | Holding | Holding | | Area | section | per | Coercivity | | |
| Sample | | Composition | size | rate | temp. | time | Pressure | ratio | area | particle | Hc1 | Hc2 | Hc2/Hc1 |
| No. | | at % | μm | ° C./min | ° C. | min | kPa | % | um2 | — | Oe | Oe | — |
| 1 | Comparative | Fe91.4Si8.6 | 25 | 5 | 850 | 60 | 0 | — | — | — | 4.5 | 11.2 | 2.49 |
| | example | | | | | | | | | | | | |
| 2 | Comparative | Fe91.4Si8.6 | 25 | 5 | 850 | 60 | 0.05 | — | — | — | 4.4 | 10.7 | 2.43 |
| | example | | | | | | | | | | | | |
| 3 | Comparative | Fe91.4Si8.6 | 25 | 5 | 850 | 60 | 0.07 | 0.1 | 0.5 | 0.9 | 4.5 | 9.6 | 2.13 |
| | example | | | | | | | | | | | | |
| 4 | Example | Fe91.4Si8.6 | 25 | 5 | 850 | 60 | 0.08 | 0.2 | 0.5 | 1.2 | 4.5 | 8.6 | 1.91 |
| 5 | Example | Fe91.4Si8.6 | 25 | 5 | 850 | 60 | 0.1 | 0.5 | 0.5 | 5.1 | 4.5 | 8.4 | 1.87 |
| 6 | Example | Fe91.4Si8.6 | 25 | 5 | 850 | 60 | 0.15 | 0.7 | 0.3 | 11.2 | 4.5 | 8.3 | 1.84 |
| 7 | Example | Fe91.4Si8.6 | 25 | 5 | 850 | 60 | 0.3 | 0.7 | 0.2 | 16.5 | 4.5 | 8.4 | 1.87 |
| 8 | Example | Fe91.4Si8.6 | 25 | 5 | 850 | 60 | 0.45 | 0.8 | 0.2 | 19.8 | 4.4 | 8.4 | 1.91 |
| 9 | Comparative | Fe91.4Si8.6 | 25 | 5 | 850 | 60 | 0.5 | 0.8 | 0.2 | 22.1 | 4.4 | 9.7 | 2.20 |
| | example | | | | | | | | | | | | |

### Evaluation 1

According to the results shown in Table 1, the nitride phase was not observed in Sample No. 1 in which the atmosphere pressure during the heat treatment was 0 kPa. The nitride phase having a cross section of 0.0005 μm² or larger was observed when the atmosphere pressure during the heat treatment was 0.07 kPa or larger, and the coercivity Hc2 of the powder of after being pressurized was smaller compared to Sample No. 1. Further, Hc2/Hc1 was smaller compared to Sample No. 1. In Sample No. 2 in which the heat treatment was carried out at the atmosphere pressure of 0.05 kPa, the nitride phase having a cross section of less than 0.0005 μm² was only observed; hence, such nitride phase was not counted. Regarding Sample No. 1 in which the nitride phase was not observed and Sample No. 2 in which the nitride phase having a cross section of less than 0.0005 μm² was only observed, Hc2/Hc1 was not lowered.

Also, from the results shown in Table 1, it was confirmed that by changing the atmosphere pressure (gauge pressure) during the heat treatment, the number of nitride phases can be controlled. When the number average of nitride phases per one particle was preferably 1 to 20 in the cross-section of the particle 2, it was confirmed that Hc2/Hc1 can be lowered. When the number average of nitride phases was less than 1, or more than 20, effect of lowering Hc2/H cl was not exhibited.

### Sample Nos. 10 to 14

Soft magnetic metal powders were produced as similar to Sample No. 5 except that the holding time of the heat treatment was changed as indicated in Table 2, and the evaluations were carried out as similar to Sample No. 5. Results are shown in Table 2.

TABLE 2

| | | | | Heat treatment | | | | Nitride phase | | | | | |
|---|---|---|---|---|---|---|---|---|---|---|---|---|---|
| | | | Ave. | Temp. | | | | | Ave. cross- | Number | | | |
| | | | particle | rising | Holding | Holding | | Area | section | per | Coercivity | | |
| Sample | | Composition | size | rate | temp. | time | Pressure | ratio | area | particle | Hc1 | Hc2 | Hc2/Hc1 |
| No | | at % | μm | ° C./min | ° C. | min | kPa | % | um2 | — | Oe | Oe | — |
| 10 | Comparative | Fe91.4Si8.6 | 25 | 5 | 850 | 10 | 0.1 | 0.05 | 0.05 | 5.1 | 4.5 | 10.2 | 2.27 |
| | example | | | | | | | | | | | | |
| 11 | Example | Fe91.4Si8.6 | 25 | 5 | 850 | 30 | 0.1 | 0.1 | 0.09 | 5.2 | 4.4 | 8.5 | 1.93 |
| 5 | Example | Fe91.4Si8.6 | 25 | 5 | 850 | 60 | 0.1 | 0.5 | 0.5 | 5.1 | 4.5 | 8.4 | 1.87 |
| 12 | Example | Fe91.4Si8.6 | 25 | 5 | 850 | 120 | 0.1 | 1.1 | 1.1 | 4.9 | 4.4 | 8.2 | 1.86 |
| 13 | Example | Fe91.4Si8.6 | 25 | 5 | 850 | 300 | 0.1 | 1.9 | 1.8 | 5.2 | 4.3 | 8.2 | 1.91 |
| 14 | Comparative | Fe91.4Si8.6 | 25 | 5 | 850 | 600 | 0.1 | 3.0 | 2.9 | 5.0 | 4.4 | 10.9 | 2.48 |
| | example | | | | | | | | | | | | |

### Evaluation 2

From the results shown in Table 2, it was confirmed that the area ratio of the nitride phases can be controlled by changing the holding time of the heat treatment. Also, it was confirmed that Hc2/Hc1 can be lowered when the area ratio of the nitride phases was preferably within a range of 0.1 to 2%. It was also confirmed that Hc2/Hc1 can be lowered, when the area ratio of the nitride phases was further preferably within a range of 0.5 to 2%.

### Sample Nos. 15 to 18

Soft magnetic metal powders were produced as similar to Sample No. 5 except that the holding temperature of the heat treatment was changed as indicated in Table 3, and the evaluations were carried out as similar to Sample No. 5. Results are shown in Table 3.

TABLE 3

| | | | | Heat treatment | | | | Nitride phase | | | | | |
|---|---|---|---|---|---|---|---|---|---|---|---|---|---|
| | | | Ave. | Temp. | | | | | Ave. cross- | Number | | | |
| | | | particle | rising | Holding | Holding | | Area | section | per | Coercity | | |
| Sample. | | Composition | size | rate | temp. | time | Pressure | ratio | area | particle | Hc1 | Hc2 | Hc2/Hc1 |
| No | | at % | μm | ° C./min | ° C. | min | kPa | % | um2 | — | Oe | Oe | — |
| 15 | Comparative | Fe91.4Si8.6 | 25 | 5 | 1030 | 60 | 0.1 | 2.0 | 10.3 | 1.0 | 4.5 | 9.9 | 2.20 |
| | example | | | | | | | | | | | | |
| 16 | Example | Fe91.4Si8.6 | 25 | 5 | 1000 | 60 | 0.1 | 2.0 | 9.4 | 1.1 | 4.5 | 8.7 | 1.93 |
| 17 | Example | Fe91.4Si8.6 | 25 | 5 | 950 | 60 | 0.1 | 1.2 | 2.5 | 2.3 | 4.4 | 8.4 | 1.91 |
| 5 | Example | Fe91.4Si8.6 | 25 | 5 | 850 | 60 | 0.1 | 0.5 | 0.5 | 5.1 | 4.5 | 8.4 | 1.87 |
| 18 | Example | Fe91.4Si8.6 | 25 | 5 | 800 | 60 | 0.1 | 0.4 | 0.4 | 4.9 | 4.4 | 8.3 | 1.89 |

### Evaluation 3

From the results shown in Table 3, it was confirmed that the cross-section area of the nitride phases can be controlled by changing the holding temperature of the heat treatment.

### Sample Nos. 19 to 21

Soft magnetic powders were produced as similar to Sample Nos. 1, 5, and 8 except that a Fe—Si-based alloy powder having the average particle size of 1 μm was used as the raw material; and the evaluations as similar to Sample Nos. 1, 5, and 8 were carried out. Results are shown in Table 4.

### Sample Nos. 22 to 24

Soft magnetic powders were produced as similar to Sample Nos. 1, 5, and 8 except that a Fe—Si-based alloy powder having the average particle size of 4 μm was used as the raw material; and the evaluations as similar to Sample Nos. 1, 5, and 8 were carried out. Results are shown in Table 4.

### Sample Nos. 25 to 27

Soft magnetic powders were produced as similar to Sample Nos. 1, 5, and 8 except that a Fe—Si-based alloy powder having the average particle size of 10 μm was used as the raw material; and the evaluations as similar to Sample Nos. 1, 5, and 8 were carried out. Results are shown in Table 4.

### Sample Nos. 28 to 30

Soft magnetic powders were produced as similar to Sample Nos. 1, 5, and 8 except that a Fe—Si-based alloy powder having the average particle size of 50 μm was used as the raw material; and the evaluations as similar to Sample Nos. 1, 5, and 8 were carried out. Results are shown in Table 4.

TABLE 4

| | | | | Heat treatment | | | | | | | | | |
|---|---|---|---|---|---|---|---|---|---|---|---|---|---|
| | | | Ave. | Temp. | | | | | Ave. cross- | Number | | | |
| | | | particle | rising | Holding | Holding | | Area | section | per | Coercivity | | |
| Sample | | Composition | size | rate | temp. | time | Pressure | ratio | area | particle | Hc1 | Hc2 | Hc2/Hc1 |
| No | | at % | μm | ° C./min | ° C. | min | kPa | % | um2 | — | Oe | Oe | — |
| 19 | Comparative | Fe91.4Si8.6 | 1 | 5 | 850 | 60 | 0 | — | — | — | 7.5 | 18.5 | 2.47 |
| | example | | | | | | | | | | | | |
| 20 | Example | Fe91.4Si8.6 | 1 | 5 | 850 | 60 | 0.1 | 0.5 | 0.003 | 1.9 | 7.5 | 14.0 | 1.87 |
| 21 | Example | Fe91.4Si8.6 | 1 | 5 | 850 | 60 | 0.45 | 0.5 | 0.0005 | 8.2 | 7.5 | 14.3 | 1.91 |
| 22 | Comparative | Fe91.4Si8.6 | 4 | 5 | 850 | 60 | 0 | — | — | — | 4.6 | 11.7 | 2.54 |
| | example | | | | | | | | | | | | |
| 23 | Example | Fe91.4Si8.6 | 4 | 5 | 850 | 60 | 0.1 | 0.5 | 0.03 | 2.4 | 4.7 | 8.8 | 1.87 |
| 24 | Example | Fe91.4Si8.6 | 4 | 5 | 850 | 60 | 0.45 | 0.5 | 0.008 | 8.4 | 4.7 | 9.0 | 1.91 |
| 25 | Comparative | Fe91.4Si8.6 | 10 | 5 | 850 | 60 | 0 | — | — | — | 4.6 | 11.5 | 2.50 |
| | example | | | | | | | | | | | | |
| 26 | Example | Fe91.4Si8.6 | 10 | 5 | 850 | 60 | 0.1 | 0.5 | 0.08 | 5.0 | 4.5 | 8.6 | 1.91 |
| 27 | Example | Fe91.4Si8.6 | 10 | 5 | 850 | 60 | 0.45 | 0.6 | 0.05 | 9.0 | 4.6 | 8.9 | 1.93 |
| 1 | Comparative | Fe91.4Si8.6 | 25 | 5 | 850 | 60 | 0 | — | — | — | 4.5 | 11.2 | 2.49 |
| | example | | | | | | | | | | | | |
| 5 | Example | Fe91.4Si8.6 | 25 | 5 | 850 | 60 | 0.1 | 0.5 | 0.5 | 5.1 | 4.5 | 8.4 | 1.87 |
| 8 | Example | Fe91.4Si8.6 | 25 | 5 | 850 | 60 | 0.45 | 0.8 | 0.2 | 19.8 | 4.4 | 8.4 | 1.91 |
| 28 | Comparative | Fe91.4Si8.6 | 50 | 5 | 850 | 60 | 0 | — | — | — | 4.3 | 11.1 | 2.58 |
| | example | | | | | | | | | | | | |
| 29 | Example | Fe91.4Si8.6 | 50 | 5 | 850 | 60 | 0.1 | 0.4 | 1.8 | 4.3 | 4.4 | 8.2 | 1.86 |
| 30 | Example | Fe91.4Si8.6 | 50 | 5 | 850 | 60 | 0.45 | 0.8 | 1.4 | 10.9 | 4.3 | 8.3 | 1.93 |

### Evaluation 4

According to the results shown in Table 4, even when the average particle size of the soft magnetic powder varied, it was confirmed that the soft magnetic metal powders of the examples which satisfied the predetermined configurations can maintain the low coercivity of the powder of after being pressurized compared to the respective comparative examples having the same particle sizes. Also, from the results shown in Table 3 and Table 4, it was confirmed that Hc2/Hc1 can be lowered when the cross-section area of the nitride phase was preferably within a range of 0.0005 to 10 μm².

Also, images of compound cross-sections of the soft magnetic powders of Sample Nos. 4 to 8, 11 to 13, and 16 to 18 were taken using SEM, and an EDX mapping image of each element was taken. Then, in the cross-section image where 50 or more magnetic particles were observed, it was confirmed that the soft magnetic alloy particles satisfying the predetermined configurations described in below were included in a number ratio of at least 50% or more.

The soft magnetic alloy particle satisfying the predetermined configurations is a particle in which one to twenty nitride phases 4 in average are observed in the cross-section of one particle 2, an area per one nitride phase 4 is within a range of 0.0005 to 10 μm², and an area ratio of the observed nitride phases 4 occupying the cross section is within in a range of 0.1 to 2%.

### Sample Nos. 31 to 34

Soft magnetic metal powders were produced as similar to Sample No. 5 except that a temperature rising rate during the heat treatment was changed as shown in Table 5. Also, the evaluations similar to Sample No. 5 was carried out. Results are shown in Table 5.

Also, in regards with examples shown in Sample Nos. 1, 5, and 31 to 34, for each soft magnetic alloy particle in which 50 or more nitride phases were observed, the average number ratio of nitride phases existing within an area of 2 μm from the surface of the soft magnetic alloy particle or the grain boundary was calculated. Results are shown in Table 5.

TABLE 5

| | | | | | | | | Nitride phase | | | | | | |
|---|---|---|---|---|---|---|---|---|---|---|---|---|---|---|
| | | | | | | | | | | | Ratio of nitride | | | |
| | | | | Heat treatment | | | | | | | phase with in a | | | |
| | | | | Temp. | | | | | Ave. | | distance of 2 μm | | | |
| | | | Ave. | rising | | | | | cross- | Number | or less from | Coercivity | | |
| | | | particle | rate | Holding | Holding | Pres- | Area | section | per | particle surface | | | Hc2/ |
| Sample | | Composition | size | ° C./ | temp. | time | sure | ratio | area | particle | or grain boundary | Hc1 | Hc2 | Hc1 |
| No | | at % | μm | min | ° C. | min | kPa | % | um2 | — | % | Oe | Oe | — |
| 1 | Comparative | Fe91.4Si8.6 | 25 | 5 | 850 | 60 | 0 | — | — | — | — | 4.5 | 11.2 | 2.49 |
| | example | | | | | | | | | | | | | |
| 31 | Example | Fe91.4Si8.6 | 25 | 3 | 850 | 60 | 0.1 | 0.6 | 0.6 | 5.0 | 45 | 4.4 | 8.5 | 1.93 |
| 5 | Example | Fe91.4Si8.6 | 25 | 5 | 850 | 60 | 0.1 | 0.5 | 0.5 | 5.1 | 52 | 4.5 | 8.4 | 1.87 |
| 32 | Example | Fe91.4Si8.6 | 25 | 10 | 850 | 60 | 0.1 | 0.4 | 0.4 | 4.7 | 80 | 4.4 | 7.9 | 1.80 |
| 33 | Example | Fe91.4Si8.6 | 25 | 15 | 850 | 60 | 0.1 | 0.4 | 0.4 | 5.0 | 94 | 4.5 | 8.4 | 1.87 |
| 34 | Example | Fe91.4Si8.6 | 25 | 20 | 850 | 60 | 0.1 | 0.5 | 0.4 | 5.9 | 97 | 4.5 | 8.8 | 1.96 |

### Evaluation 5

From the results shown in Table 5, it was confirmed that the area ratio of the nitride phases existing near the grain boundary of the particles or the particle surface can be controlled by changing the temperature rising rate during the heat treatment. Also, it was confirmed that Hc2/Hc1 can be further lowered when the nitride phases are distributed so that the number ratio of the nitride phases existing within the area of 2 μm from the surface of the soft magnetic alloy particle 2 or the crystal grain boundary was preferably 45% or more and 95% or less, more preferably 50% or more and 95% or less, or more preferably 80% or more and 90% or less with respect to the entire nitride phases.

### Sample Nos. 35 and 36

Soft magnetic metal powders were produced as similar to Sample Nos. 1 and 5 except that simple Fe, simple Co, and simple Si were mixed and used as a raw material so that a composition of the soft magnetic metal powder was (Fe₉₀Co₁₀)_{91.4}Si_{8.6}. The evaluations similar to Sample Nos. 1 and 5 were carried out. Results are shown in Table 6.

### Sample Nos. 37 and 38

Soft magnetic metal powders were produced as similar to Sample Nos. 1 and 5 except that simple Fe, simple Co, and simple Si were mixed and used as a raw material so that a composition of the soft magnetic metal powder was (Fe₈₀Co₂₀)_{91.4}Si_{8.6}. The evaluations similar to Sample Nos. 1 and 5 were carried out. Results are shown in Table 6.

### Sample Nos. 39 and 40

Soft magnetic metal powders were produced as similar to Sample Nos. 1 and 5 except that simple Fe, simple Co, and simple Si were mixed and used as a raw material so that a composition of the soft magnetic metal powder was (Fe₇₀Co₃₀)_{91.4}Si_{8.6}. The evaluations similar to Sample Nos. 1 and 5 were carried out. Results are shown in Table 6.

### Sample Nos. 41 and 42

Soft magnetic metal powders were produced as similar to Sample Nos. 1 and 5 except that simple Fe, simple Co, and simple Si were mixed and used as a raw material so that a composition of the soft magnetic metal powder was (Fe₆₀Co₄₀)_{91.4}Si_{8.6}. The evaluations similar to Sample Nos. 1 and 5 were carried out. Results are shown in Table 6.

### Sample Nos. 43 and 44

Soft magnetic metal powders were produced as similar to Sample Nos. 1 and 5 except that simple Fe, simple Co, and simple Si were mixed and used as a raw material so that a composition of the soft magnetic metal powder was (Fe₄₀Co₆₀)_{91.4}Si_{8.6}. The evaluations similar to Sample Nos. 1 and 5 were carried out. Results are shown in Table 6.

### [Table 6]

TABLE 6

| | | | | | | | | Nitride phase | | | | | |
|---|---|---|---|---|---|---|---|---|---|---|---|---|---|
| | | | | Heat treatment | | | | | Ave. | | | | |
| | | | Ave. | Temp. | | | | | cross- | Number | Coercivity | | |
| | | | particle | rising | Holding | Holding | | Area | section | per | | | Hc2/ |
| Sample | | Composition | size | rate | temp. | time | Pressure | ratio | area | particle | Hc1 | Hc2 | Hc1 |
| No | | at % | μm | ° C./min | ° C. | min | kPa | % | um2 | — | 0e | 0e | — |
| 1 | Comparative | Fe91.4Si8.6 | 25 | 5 | 850 | 60 | 0 | — | — | — | 4.5 | 11.2 | 2.49 |
| | example | | | | | | | | | | | | |
| 5 | Example | Fe91.4Si8.6 | 25 | 5 | 850 | 60 | 0.1 | 0.5 | 0.5 | 5.1 | 4.5 | 8.4 | 1.87 |
| 35 | Comparative | (Fe90Co10)91.4Si8.6 | 25 | 5 | 850 | 60 | 0 | — | — | — | 4.5 | 11.1 | 2.47 |
| | example | | | | | | | | | | | | |
| 36 | Example | (Fe90Co10)91.4Si8.6 | 25 | 5 | 850 | 60 | 0.1 | 1.0 | 0.7 | 7.1 | 4.5 | 8.1 | 1.80 |
| 37 | Comparative | (Fe80Co20)91.4Si8.6 | 25 | 5 | 850 | 60 | 0 | — | — | — | 4.6 | 11.3 | 2.46 |
| | example | | | | | | | | | | | | |
| 38 | Example | (Fe80Co20)91.4Si8.6 | 25 | 5 | 850 | 60 | 0.1 | 1.3 | 0.8 | 8.0 | 4.6 | 8.3 | 1.80 |
| 39 | Comparative | (Fe70Co30)91.4Si8.6 | 25 | 5 | 850 | 60 | 0 | — | — | — | 4.7 | 11.4 | 2.43 |
| | example | | | | | | | | | | | | |
| 40 | Example | (Fe70Co30)91.4Si8.6 | 25 | 5 | 850 | 60 | 0.1 | 1.7 | 1.0 | 8.3 | 4.7 | 8.3 | 1.77 |
| 41 | Comparative | (Fe60Co40)91.4Si8.6 | 25 | 5 | 850 | 60 | 0 | — | — | — | 4.6 | 11.3 | 2.46 |
| | example | | | | | | | | | | | | |
| 42 | Example | (Fe60Co40)91.4Si8.6 | 25 | 5 | 850 | 60 | 0.1 | 1.6 | 0.9 | 8.7 | 4.6 | 8.4 | 1.83 |
| 43 | Comparative | (Fe40Co60)91.4Si8.6 | 25 | 5 | 850 | 60 | 0 | — | — | — | 4.5 | 11.1 | 2.47 |
| | example | | | | | | | | | | | | |
| 44 | Example | (Fe40Co60)91.4Si8.6 | 25 | 5 | 850 | 60 | 0.1 | 1.7 | 0.9 | 8.9 | 4.5 | 8.4 | 1.87 |

### Evaluation 6

From the results shown in Table 6, it was confirmed that in the case that the soft magnetic powder included Co, the soft magnetic metal powder of the examples satisfying the predetermined configurations was able to further lower Hc2/Hc1 compared to the respective comparative example having the equivalent composition.

### Sample Nos. 45 to 48

Soft magnetic metal powders were produced as similar to Sample No. 5 except that the heat treatment atmosphere was changed as shown in Table 7. Evaluations similar to Sample No. 5 were carried out. Results are shown in Table 7.

TABLE 7

| | | | | Heat treatment | | | | | | Nitride phase | | | | | | |
|---|---|---|---|---|---|---|---|---|---|---|---|---|---|---|---|---|
| | | | Ave. | | | Temp. | | | | Ni- | | Ave. | Number | | | |
| | | | par- | | Oxygen | rising | Hold- | Hold- | | trogen | | cross- | per | Coercivity | | |
| Sam- | | | ticle | | concen- | rate | ing | ing | Pres- | concen- | Area | section | par- | | | Hc2/ |
| ple | | Composition | size | Atmo- | tration | ° C./ | temp. | time | sure | tration | ratio | area | ticle | Hc1 | Hc2 | Hc1 |
| No | | at % | μm | sphere | ppm | min | ° C. | min | kPa | at % | % | um2 | — | Oe | Oe | — |
| 5 | Example | Fe91.4Si8.6 | 25 | N2 | 200 | 5 | 850 | 60 | 0.1 | 57.9 | 0.5 | 0.5 | 5.1 | 4.5 | 8.4 | 1.87 |
| 45 | Example | Fe91.4S18.6 | 25 | N2 + Air | 300 | 5 | 850 | 60 | 0.1 | 54.6 | 0.4 | 0.4 | 4.8 | 4.4 | 8.2 | 1.86 |
| 46 | Example | Fe91.4Si8.6 | 25 | N2 + Air | 350 | 5 | 850 | 60 | 0.1 | 42.8 | 0.3 | 0.3 | 4.7 | 4.5 | 8.4 | 1.87 |
| 47 | Example | Fe91.4Si8.6 | 25 | N2 + Air | 400 | 5 | 850 | 60 | 0.1 | 31.3 | 0.3 | 0.3 | 4.6 | 4.4 | 8.5 | 1.93 |
| 48 | Example | Fe91.4Si8.6 | 25 | N2 + Air | 500 | 5 | 850 | 60 | 0.1 | 23.7 | 0.2 | 0.3 | 3.4 | 4.4 | 8.8 | 2.00 |

### Evaluation 7

From the results shown in Table 7, it was confirmed that even when the nitrogen concentration in the nitride phase differed, the soft magnetic metal powder of the examples which satisfied the predetermined configurations can maintain the low coercivity after being pressurized. Also, when a ratio of nitrogen in the nitride phase 4 was preferably 20 atom % or more, or 30 atom % or more, it was confirmed that Hc2/Hc1 can be particularly lowered.

### Sample Nos. 49 to 156

Soft magnetic metal powders were produced as similar to Sample Nos. 1 or 5 except that simple Fe, simple Si, simple Cr, simple Co, simple C, simple Al, simple S, simple Ti, simple V, simple Mn, simple Ni, and simple Cu were mixed and used as a raw material so that compositions of the soft magnetic metal powders satisfied as shown in Tables 8 to 11. Evaluations similar to Sample Nos. 1 or 5 were carried out. Results are shown in Tables 8 to 11.

TABLE 8

| | | | | | | | | Nitride phase | | | | | |
|---|---|---|---|---|---|---|---|---|---|---|---|---|---|
| | | | | Heat treatment | | | | | Ave. | | | | |
| | | | Ave. | Temp. | | | | | cross- | Number | | | |
| | | | particle | rising | Holding | Holding | | Area | section | per | Coercivity | | |
| Sample | | Composition | size | rate | temp. | time | Pressure | ratio | area | particle | Hc1 | Hc2 | Hc2/Hc1 |
| No | | at % | μm | ° C./min | ° C. | min | kPa | % | um2 | — | Oe | Oe | — |
| 49 | Comparative | Fe89.82Si9.98Cr0.2 | 25 | 5 | 850 | 60 | 0 | — | — | — | 4.3 | 10.8 | 2.51 |
| | example | | | | | | | | | | | | |
| 50 | Example | Fe89.82Si9.98Cr0.2 | 25 | 5 | 850 | 60 | 0.1 | 0.3 | 0.3 | 4.9 | 4.3 | 8.1 | 1.88 |
| 51 | Comparative | Fe89.55Si9.95Cr0.5 | 25 | 5 | 850 | 60 | 0 | — | — | — | 4.2 | 10.6 | 2.52 |
| | example | | | | | | | | | | | | |
| 52 | Example | Fe89.55Si9.95Cr0.5 | 25 | 5 | 850 | 60 | 0.1 | 0.2 | 0.2 | 4.8 | 4.1 | 8.0 | 1.95 |
| 53 | Comparative | Fe89.11Si9.90Cr0.99 | 25 | 5 | 850 | 60 | 0 | — | — | — | 4.0 | 10.4 | 2.60 |
| | example | | | | | | | | | | | | |
| 54 | Example | Fe89.11Si9.90Cr0.99 | 25 | 5 | 850 | 60 | 0.1 | 0.2 | 0.3 | 3.1 | 4.0 | 7.8 | 1.95 |
| 55 | Comparative | Fe88.24Si9.8Cr1.96 | 25 | 5 | 850 | 60 | 0 | — | — | — | 3.9 | 10.3 | 2.64 |
| | example | | | | | | | | | | | | |
| 56 | Example | Fe88.24Si9.8Cr1.96 | 25 | 5 | 850 | 60 | 0.1 | 0.2 | 0.3 | 2.7 | 3.8 | 7.7 | 2.03 |
| 57 | Comparative | Fe88.57Si6.67Cr4.76 | 25 | 5 | 850 | 60 | 0 | — | — | — | 3.9 | 10.4 | 2.67 |
| | example | | | | | | | | | | | | |
| 58 | Example | Fe88.57Si6.67Cr4.76 | 25 | 5 | 850 | 60 | 0.1 | 0.1 | 0.1 | 6.1 | 3.9 | 7.8 | 2.00 |
| 59 | Comparative | Fe86.92Si6.54Cr6.54 | 25 | 5 | 850 | 60 | 0 | — | — | — | 3.8 | 10.2 | 2.68 |
| | example | | | | | | | | | | | | |
| 60 | Example | Fe86.92Si6.54Cr6.54 | 25 | 5 | 850 | 60 | 0.1 | 0.1 | 0.07 | 7.5 | 3.7 | 7.6 | 2.05 |
| 61 | Comparative | Fe86.11Si6.48Cr7.41 | 25 | 5 | 850 | 60 | 0 | — | — | — | 3.7 | 10.0 | 2.70 |
| | example | | | | | | | | | | | | |
| 62 | Example | Fe86.11Si6.48Cr7.41 | 25 | 5 | 850 | 60 | 0.1 | 0.1 | 0.04 | 9.3 | 3.6 | 7.3 | 2.03 |

TABLE 9

| | | | | Heat treatment | | | | | | | | | | |
|---|---|---|---|---|---|---|---|---|---|---|---|---|---|---|
| | | | Ave. | | Temp. | | | | | Ave | Number | | | |
| | | | par- | | rising | Hold- | Hold- | | | cross- | per | Coercivity | | |
| Sam- | | | ticle | Atmo- | rate | ing | ing | Pres- | Area | section | par- | | | Hc2/ |
| ple | | Composition | size | sphere | ° C./ | temp. | time | sure | ratio | area | ticle | Hc1 | Hc2 | Hc1 |
| No | | at % | μm | — | min | ° C. | min | kPa | % | um2 | — | Oe | Oe | — |
| 63 | Comparative | (Fe90Co10)88Si12 | 25 | N₂ | 5 | 850 | 60 | 0 | — | — | — | 3.8 | 9.9 | 2.61 |
| | example | | | | | | | | | | | | | |
| 64 | Example | (Fe90Co10)88Si12 | 25 | N₂ | 5 | 850 | 60 | 0.1 | 1.3 | 0.8 | 8.0 | 3.8 | 7.0 | 1.84 |
| 65 | Comparative | (Fe90Co10)87.82Si11.98Cr0.2 | 25 | N₂ | 5 | 850 | 60 | 0 | — | — | — | 3.9 | 10.3 | 2.64 |
| | example | | | | | | | | | | | | | |
| 66 | Example | (Fe90Co10)87.82Si11.98Cr0.2 | 25 | N₂ | 5 | 850 | 60 | 0.1 | 1.0 | 0.6 | 8.2 | 3.9 | 7.3 | 1.87 |
| 67 | Comparative | (Fe90Co10)87.56Si11.94Cr0.5 | 25 | N₂ | 5 | 850 | 60 | 0 | — | — | — | 3.8 | 10.2 | 2.68 |
| | example | | | | | | | | | | | | | |
| 68 | Example | (Fe90Co10)87.56Si11.94Cr0.5 | 25 | N₂ | 5 | 850 | 60 | 0.1 | 0.5 | 0.3 | 8.3 | 3.8 | 7.0 | 1.84 |
| 69 | Comparative | (Fe90Co10)87.13Si11.88Cr0.99 | 25 | N₂ | 5 | 850 | 60 | 0 | — | — | — | 3.7 | 10.1 | 2.73 |
| | example | | | | | | | | | | | | | |
| 70 | Example | (Fe90Co10)87.13Si11.88Cr0.99 | 25 | N₂ | 5 | 850 | 60 | 0.1 | 0.2 | 0.3 | 3.4 | 3.7 | 6.9 | 1.86 |
| 71 | Comparative | (Fe90Co10)86.27Si11.76Cr1.96 | 25 | N₂ | 5 | 850 | 60 | 0 | — | — | — | 3.6 | 9.8 | 2.72 |
| | example | | | | | | | | | | | | | |
| 72 | Example | (Fe90Co10)86.27Si11.76Cr1.96 | 25 | N₂ | 5 | 850 | 60 | 0.1 | 0.2 | 0.3 | 3.1 | 3.6 | 6.7 | 1.86 |
| 73 | Comparative | (Fe90Co10)88.57Si6.67Cr4.76 | 25 | N₂ | 5 | 850 | 60 | 0 | — | — | — | 3.8 | 9.9 | 2.61 |
| | example | | | | | | | | | | | | | |
| 74 | Example | (Fe90Co10)88.57Si6.67Cr4.76 | 25 | N₂ | 5 | 850 | 60 | 0.1 | 0.2 | 0.2 | 3.5 | 3.8 | 7.0 | 1.84 |
| 75 | Comparative | (Fe90Co10)86.92Si6.54Cr6.54 | 25 | N₂ | 5 | 850 | 60 | 0 | — | — | — | 3.7 | 9.9 | 2.68 |
| | example | | | | | | | | | | | | | |
| 76 | Example | (Fe90Co10)86.92Si6.54Cr6.54 | 25 | N₂ | 5 | 850 | 60 | 0.1 | 0.1 | 0.1 | 4.7 | 3.7 | 6.9 | 1.86 |
| 77 | Comparative | (Fe75Co25)90Si10 | 25 | N₂ | 5 | 850 | 60 | 0 | — | — | — | 4.3 | 10.5 | 2.44 |
| | example | | | | | | | | | | | | | |
| 78 | Example | (Fe75Co25)90Si10 | 25 | N₂ | 5 | 850 | 60 | 0.1 | 1.6 | 0.9 | 9.0 | 4.2 | 7.5 | 1.79 |
| 79 | Comparative | (Fe75Co25)89.82Si9.98Cr0.2 | 25 | N₂ | 5 | 850 | 60 | 0 | — | — | — | 4.2 | 10.3 | 2.45 |
| | example | | | | | | | | | | | | | |
| 80 | Example | (Fe75Co25)89.82Si9.98Cr0.2 | 25 | N₂ | 5 | 850 | 60 | 0.1 | 1.0 | 0.4 | 10.2 | 4.2 | 7.7 | 1.83 |
| 81 | Comparative | (Fe75Co25)89.55Si9.95Cr0.5 | 25 | N₂ | 5 | 850 | 60 | 0 | — | — | — | 4.1 | 10.2 | 2.49 |
| | example | | | | | | | | | | | | | |
| 82 | Example | (Fe75Co25)89.55Si9.95Cr0.5 | 25 | N₂ | 5 | 850 | 60 | 0.1 | 0.7 | 0.4 | 8.0 | 4.1 | 7.6 | 1.85 |
| 83 | Comparative | (Fe75Co25)89.11Si9.90Cr0.99 | 25 | N₂ | 5 | 850 | 60 | 0 | — | — | — | 4.0 | 10.1 | 2.53 |
| | example | | | | | | | | | | | | | |
| 84 | Example | (Fe75Co25)89.11Si9.90Cr0.99 | 25 | N₂ | 5 | 850 | 60 | 0.1 | 0.4 | 0.3 | 6.5 | 4.1 | 7.5 | 1.83 |
| 85 | Comparative | (Fe75Co25)88.24Si9.8Cr1.96 | 25 | N₂ | 5 | 850 | 60 | 0 | — | — | — | 3.9 | 10.0 | 2.56 |
| | example | | | | | | | | | | | | | |
| 86 | Example | (Fe75Co25)88.24Si9.8Cr1.96 | 25 | N₂ | 5 | 850 | 60 | 0.1 | 0.2 | 0.2 | 4.7 | 4.0 | 7.4 | 1.85 |
| 87 | Comparative | (Fe75Co25)88.57Si6.67Cr4.76 | 25 | N₂ | 5 | 850 | 60 | 0 | — | — | — | 4.1 | 10.3 | 2.51 |
| | example | | | | | | | | | | | | | |
| 88 | Example | (Fe75Co25)88.57Si6.67Cr4.76 | 25 | N₂ | 5 | 850 | 60 | 0.1 | 0.2 | 0.1 | 8.8 | 4.0 | 7.4 | 1.85 |
| 89 | Comparative | (Fe75Co25)86.92Si6.54Cr6.54 | 25 | N₂ | 5 | 850 | 60 | 0 | — | — | — | 3.9 | 10.0 | 2.56 |
| | example | | | | | | | | | | | | | |
| 90 | Example | (Fe75Co25)86.92Si6.54Cr6.54 | 25 | N₂ | 5 | 850 | 60 | 0.1 | 0.1 | 0.1 | 5.2 | 3.8 | 7.0 | 1.84 |

TABLE 10

| | | | | | | | | Nitride phase | | | | | |
|---|---|---|---|---|---|---|---|---|---|---|---|---|---|
| | | | | Heat treatment | | | | | Ave. | | | | |
| | | | Ave. | Temp. | | | | | cross- | Number | Coeroivity | | |
| | | | particle | rising | Holding | Holding | | Area | section | per | | | Hc2/ |
| Sample | | Composition | size | rate | temp. | time | Pressure | ratio | area | particle | Hc1 | Hc2 | Hc1 |
| No | | at % | μm | ° C./min | ° C. | min | kPa | % | um2 | — | Oe | Oe | — |
| 91 | Comparative | Fe86Si12Cr2 | 25 | 5 | 850 | 60 | 0 | — | — | — | 3.5 | 9.2 | 2.63 |
| | example | | | | | | | | | | | | |
| 92 | Example | Fe86Si12Cr2 | 25 | 5 | 850 | 60 | 0.1 | 0.2 | 0.3 | 3.2 | 3.4 | 6.7 | 1.97 |
| 93 | Comparative | Fe85.5Si12Cr200.5 | 25 | 5 | 850 | 60 | 0 | — | — | — | 3.4 | 9.0 | 2.65 |
| | example | | | | | | | | | | | | |
| 94 | Example | Fe85.5Si12Cr200.5 | 25 | 5 | 850 | 60 | 0.1 | 0.2 | 0.2 | 5.5 | 3.3 | 6.5 | 1.97 |
| 95 | Comparative | Fe84Si12Cr202 | 25 | 5 | 850 | 60 | 0 | — | — | — | 3.3 | 8.8 | 2.67 |
| | example | | | | | | | | | | | | |
| 96 | Example | Fe84Si12Cr202 | 25 | 5 | 850 | 60 | 0.1 | 0.1 | 0.2 | 3.1 | 3.2 | 6.3 | 1.97 |
| 97 | Comparative | Fe85.5Si2Cr2Al0.5 | 25 | 5 | 850 | 60 | 0 | — | — | — | 3.4 | 9.1 | 2.68 |
| | example | | | | | | | | | | | | |
| 98 | Example | Fe85.5Si12Cr2Al0.5 | 25 | 5 | 850 | 60 | 0.1 | 0.1 | 0.2 | 3.0 | 3.4 | 6.4 | 1.88 |
| 99 | Comparative | Fe84Si12Cr2Al2 | 25 | 5 | 850 | 60 | 0 | — | — | — | 3.3 | 8.9 | 2.70 |
| | example | | | | | | | | | | | | |
| 100 | Example | Fe84Si12Cr2Al2 | 25 | 5 | 850 | 60 | 0.1 | 0.3 | 0.3 | 4.7 | 3.3 | 6.3 | 1.91 |
| 101 | Comparative | Fe85.975Si12Cr2S0.025 | 25 | 5 | 850 | 60 | 0 | — | — | — | 3.5 | 9.1 | 2.60 |
| | example | | | | | | | | | | | | |
| 102 | Example | Fe85.975Si12Cr2S0.025 | 25 | 5 | 850 | 60 | 0.1 | 0.3 | 0.3 | 4.4 | 3.4 | 6.5 | 1.91 |
| 103 | Comparative | Fe85Si12Cr2S1 | 25 | 5 | 850 | 60 | 0 | — | — | — | 3.4 | 8.9 | 2.62 |
| | example | | | | | | | | | | | | |
| 104 | Example | Fe85Si12Cr2S1 | 25 | 5 | 850 | 60 | 0.1 | 0.1 | 0.3 | 1.7 | 3.3 | 6.4 | 1.94 |
| 105 | Comparative | Fe85.5Si12Cr2Ti0.5 | 25 | 5 | 850 | 60 | 0 | — | — | — | 3.4 | 8.8 | 2.59 |
| | example | | | | | | | | | | | | |
| 106 | Example | Fe85.5Si12Cr2Ti0.5 | 25 | 5 | 850 | 60 | 0.1 | 0.2 | 0.3 | 3.3 | 3.4 | 6.5 | 1.91 |
| 107 | Comparative | Fe84Si12Cr2Ti2 | 25 | 5 | 850 | 60 | 0 | — | — | — | 3.4 | 8.8 | 2.59 |
| | example | | | | | | | | | | | | |
| 108 | Example | Fe84Si12Cr2Ti2 | 25 | 5 | 850 | 60 | 0.1 | 0.1 | 0.1 | 4.2 | 3.3 | 6.4 | 1.94 |
| 109 | Comparative | Fe85.5Si12Cr2V0.5 | 25 | 5 | 850 | 60 | 0 | — | — | — | 3.5 | 8.7 | 2.49 |
| | example | | | | | | | | | | | | |
| 110 | Example | Fe85.5Si12Cr2V0.5 | 25 | 5 | 850 | 60 | 0.1 | 0.3 | 0.2 | 6.3 | 3.4 | 6.5 | 1.91 |
| 111 | Comparative | Fe84Si12Cr2V2 | 25 | 5 | 850 | 60 | 0 | — | — | — | 3.3 | 8.8 | 2.67 |
| | example | | | | | | | | | | | | |
| 112 | Example | Fe84Si12Cr2V2 | 25 | 5 | 850 | 60 | 0.1 | 0.2 | 0.3 | 3.4 | 3.3 | 6.3 | 1.91 |
| 113 | Comparative | Fe85.5Si12Cr2Mn0.5 | 25 | 5 | 850 | 60 | 0 | — | — | — | 3.4 | 8.7 | 2.56 |
| | example | | | | | | | | | | | | |
| 114 | Example | Fe85.5Si12Cr2Mn0.5 | 25 | 5 | 850 | 60 | 0.1 | 0.1 | 0.2 | 2.4 | 3.3 | 6.5 | 1.97 |
| 115 | Comparative | Fe84Si12Cr2Mn2 | 25 | 5 | 850 | 60 | 0 | — | — | — | 3.3 | 8.9 | 2.70 |
| | example | | | | | | | | | | | | |
| 116 | Example | Fe84Si12Cr2Mn2 | 25 | 5 | 850 | 60 | 0.1 | 0.1 | 0.3 | 1.5 | 3.4 | 6.3 | 1.85 |
| 117 | Comparative | Fe85.5Si12Cr2Ni0.5 | 25 | 5 | 850 | 60 | 0 | — | — | — | 3.5 | 8.7 | 2.49 |
| | example | | | | | | | | | | | | |
| 118 | Example | Fe85.5Si12Cr2Ni0.5 | 25 | 5 | 850 | 60 | 0.1 | 0.2 | 0.2 | 4.6 | 3.4 | 6.5 | 1.91 |
| 119 | Comparative | Fe84Si12Cr2Ni2 | 25 | 5 | 850 | 60 | 0 | — | — | — | 3.4 | 8.7 | 2.56 |
| | example | | | | | | | | | | | | |
| 120 | Example | Fe84Si12Cr2Ni2 | 25 | 5 | 850 | 60 | 0.1 | 0.1 | 0.4 | 1.1 | 3.4 | 6.3 | 1.85 |
| 121 | Comparative | Fe85.5Si12Cr2Cu0.5 | 25 | 5 | 850 | 60 | 0 | — | — | — | 3.5 | 8.9 | 2.54 |
| | example | | | | | | | | | | | | |
| 122 | Example | Fe85.5Si12Cr2Cu0.5 | 25 | 5 | 850 | 60 | 0.1 | 0.3 | 0.2 | 6.6 | 3.5 | 6.6 | 1.89 |
| 123 | Comparative | Fe84Si12Cr2Cu2 | 25 | 5 | 850 | 60 | 0 | — | — | — | 3.3 | 8.6 | 2.61 |
| | example | | | | | | | | | | | | |
| 124 | Example | Fe84Si12Cr2Cu2 | 25 | 5 | 850 | 60 | 0.1 | 0.2 | 0.2 | 5.1 | 3.4 | 6.5 | 1.91 |

TABLE 11

| | | | | | | | | Nitride phase | | | | | |
|---|---|---|---|---|---|---|---|---|---|---|---|---|---|
| | | | | Heat treatment | | | | | Ave. | | | | |
| | | | Ave. | Temp. | | | | | cross- | Number | Coercivity | | |
| | | | particle | rising | Holding | Holding | Pres- | Area | section | per | | | Hc2/ |
| Sample | | Composition | size | rate | temp. | time | sure | ratio | area | particle | Hc1 | Hc2 | Hc1 |
| No | | at % | μm | ° C./min | ° C. | min | kPa | % | um2 | — | Oe | Oe | — |
| 125 | Comparative | (Fe90Co10)87.5Si12C0.5 | 25 | 5 | 850 | 60 | 0 | — | — | — | 3.9 | 9.8 | 2.51 |
| | example | | | | | | | | | | | | |
| 126 | Example | (Fe90Co10)87.5Si2C0.5 | 25 | 5 | 850 | 60 | 0.1 | 1.5 | 0.9 | 8.0 | 3.8 | 7.0 | 1.84 |
| 127 | Comparative | (Fe90Co10)86Si2C2 | 25 | 5 | 850 | 60 | 0 | — | — | — | 3.7 | 9.4 | 2.54 |
| | example | | | | | | | | | | | | |
| 128 | Example | (Fe90Co10)86Si12C2 | 25 | 5 | 850 | 60 | 0.1 | 1.7 | 0.8 | 10.4 | 3.6 | 6.6 | 1.83 |
| 129 | Comparative | (Fe90Co10)87.5Si12Al0.5 | 25 | 5 | 850 | 60 | 0 | — | — | — | 3.8 | 9.7 | 2.55 |
| | example | | | | | | | | | | | | |
| 130 | Example | (Fe90Co10)87.5Si12Al0.5 | 25 | 5 | 850 | 60 | 0.1 | 1.7 | 0.6 | 13.3 | 3.8 | 6.9 | 1.82 |
| 131 | Comparative | (Fe90Co10)86Si12Al2 | 25 | 5 | 850 | 60 | 0 | — | — | — | 3.6 | 9.5 | 2.64 |
| | example | | | | | | | | | | | | |
| 132 | Example | (Fe90Co10)86Si12Al2 | 25 | 5 | 850 | 60 | 0.1 | 1.5 | 0.9 | 8.0 | 3.6 | 6.7 | 1.86 |
| 133 | Comparative | (Fe90Co10)87.975Si12S0.025 | 25 | 5 | 850 | 60 | 0 | — | — | — | 4.0 | 10.0 | 2.50 |
| | example | | | | | | | | | | | | |
| 134 | Example | (Fe90Co10)87.975Si12S0.025 | 25 | 5 | 850 | 60 | 0.1 | 1.8 | 1.0 | 8.7 | 3.9 | 7.1 | 1.82 |
| 135 | Comparative | (Fe90Co10)87.9Si12S0.1 | 25 | 5 | 850 | 60 | 0 | — | — | — | 3.9 | 9.5 | 2.44 |
| | example | | | | | | | | | | | | |
| 136 | Example | (Fe90Co10)87.9Si12S0.1 | 25 | 5 | 850 | 60 | 0.1 | 1.4 | 0.8 | 8.0 | 3.8 | 6.8 | 1.79 |
| 137 | Comparative | (Fe90Co10)87.5Si12Ti0.5 | 25 | 5 | 850 | 60 | 0 | — | — | — | 3.8 | 9.8 | 2.58 |
| | example | | | | | | | | | | | | |
| 138 | Example | (Fe90Co10)87.5Si12Ti0.5 | 25 | 5 | 850 | 60 | 0.1 | 1.7 | 0.6 | 14.2 | 3.8 | 7.0 | 1.84 |
| 139 | Comparative | (Fe90Co10)86Si12Ti2 | 25 | 5 | 850 | 60 | 0 | — | — | — | 3.5 | 9.6 | 2.74 |
| | example | | | | | | | | | | | | |
| 140 | Example | (Fe90Co10)86Si12Ti2 | 25 | 5 | 850 | 60 | 0.1 | 1.3 | 0.4 | 15.1 | 3.6 | 6.7 | 1.86 |
| 141 | Comparative | (Fe90Co10)87.5Si12V0.5 | 25 | 5 | 850 | 60 | 0 | — | — | — | 3.6 | 9.7 | 2.69 |
| | example | | | | | | | | | | | | |
| 142 | Example | (Fe90Co10)87.5Si12V0.5 | 25 | 5 | 850 | 60 | 0.1 | 1.6 | 0.8 | 9.9 | 3.7 | 6.9 | 1.86 |
| 143 | Comparative | (Fe90Co10)86Si12V2 | 25 | 5 | 850 | 60 | 0 | — | — | — | 3.6 | 9.3 | 2.58 |
| | example | | | | | | | | | | | | |
| 144 | Example | (Fe90Co10)86Si12V2 | 25 | 5 | 850 | 60 | 0.1 | 1.7 | 1.9 | 4.6 | 3.6 | 6.6 | 1.83 |
| 145 | Comparative | (Fe90Co10)87.5Si12Mn0.5 | 25 | 5 | 850 | 60 | 0 | — | — | — | 3.6 | 9.8 | 2.72 |
| | example | | | | | | | | | | | | |
| 146 | Example | (Fe90Co10)87.5Si12Mn0.5 | 25 | 5 | 850 | 60 | 0.1 | 1.5 | 1.7 | 4.4 | 3.6 | 6.7 | 1.86 |
| 147 | Comparative | (Fe90Co10)86Si12Mn2 | 25 | 5 | 850 | 60 | 0 | — | — | — | 3.6 | 9.4 | 2.61 |
| | example | | | | | | | | | | | | |
| 148 | Example | (Fe90Co10)86Si12Mn2 | 25 | 5 | 850 | 60 | 0.1 | 1.1 | 0.9 | 6.0 | 3.6 | 6.6 | 1.83 |
| 149 | Comparative | (Fe90Co10)87.5Si12Ni0.5 | 25 | 5 | 850 | 60 | 0 | — | — | — | 3.7 | 9.8 | 2.65 |
| | example | | | | | | | | | | | | |
| 150 | Example | (Fe90Co10)87.5Si12Ni0.5 | 25 | 5 | 850 | 60 | 0.1 | 1.4 | 1.0 | 7.0 | 3.8 | 7.0 | 1.84 |
| 151 | Comparative | (Fe90Co10)86Si12Ni2 | 25 | 5 | 850 | 60 | 0 | — | — | — | 3.6 | 9.5 | 2.64 |
| | example | | | | | | | | | | | | |
| 152 | Example | (Fe90Co10)86Si12Ni2 | 25 | 5 | 850 | 60 | 0.1 | 1.6 | 1.8 | 4.5 | 3.6 | 6.7 | 1.86 |
| 153 | Comparative | (Fe90Co10)87.5Si12Cu0.5 | 25 | 5 | 850 | 60 | 0 | — | — | — | 3.9 | 9.9 | 2.54 |
| | example | | | | | | | | | | | | |
| 154 | Example | (Fe90Co10)87.5Si12Cu0.5 | 25 | 5 | 850 | 60 | 0.1 | 1.2 | 0.7 | 8.2 | 3.8 | 6.8 | 1.79 |
| 155 | Comparative | (Fe90Co10)86Si12Cu2 | 25 | 5 | 850 | 60 | 0 | — | — | — | 3.6 | 9.6 | 2.67 |
| | example | | | | | | | | | | | | |
| 156 | Example | (Fe90Co10)86Si12Cu2 | 25 | 5 | 850 | 60 | 0.1 | 1.6 | 0.7 | 10.8 | 3.6 | 6.6 | 1.83 |

### Evaluation 8

From the results shown in Tables 8 to 11, it was confirmed that even in the case that the compositions of the soft magnetic powders differed, the soft magnetic metal powders of the examples satisfying the predetermined configurations can lower Hc2/Hc1 compared to the respective comparative examples having the equivalent compositions.

### Sample Nos. 157 and 158

Regarding the soft magnetic alloy powders of Sample Nos. 1 and 5, dust cores were produced by going through steps described in below, and evaluations were carried out.

### [Production of Dust Core]

An epoxy resin as a binder was added to the soft magnetic powder of after the heat treatment to produce a granulated powder. Note that, a type and an added amount of the epoxy resin were determined according to the average particle size of each soft magnetic powder. This granulated powder was used for molding at a molding pressure of 8 ton/cm² so as to obtain a molded body having a toroidal shape of an outer diameter of 18 mm×an inner diameter of 10 mm×a height 5 mm. Next, the molded body was maintained at 180° C. for 3 hours in the air to cure the resin; thereby, a dust core having a toroidal shape was obtained.

### [Evaluation of Dust Core]

### (Measurement of Permeability)

Regarding the dust cores produced using the soft magnetic powders of Sample No. 1 and Sample No. 5, a relative permeability μ′ at frequency of 1 MHz was measured. For the measurement of the relative permeability μ′, an RF impedance material analyzer (4991A made by Agilent Technologies) was used. Results are shown in Table 12.

### (Measurement of Core Loss (Power Loss) Pcv)

Regarding the dust cores produced using the soft magnetic powders of Samples No. 1 and Sample No. 5, a primary wire was wound for 30 turns, and a secondary wire was wound for 10 turns around the dust cores. Then, a core loss Pcv was measured at a measurement frequency of 3 M Hz and a magnetic flux density of 10 mT. For the measurement of Pcv, a BH analyzer (SY-8218 made by IWATSU ELECTRIC CO., LTD.) was used. Results are shown in Table 12.

### Sample Nos. 159, 161, 163, 165, and 167

Dust cores were produced as similar to Sample No. 157 except that the soft magnetic powders formed with coating layers having materials and thicknesses as indicated in Table 12 were used instead of the soft magnetic powder of Sample No. 1. Then, evaluations similar to Sample No. 157 were carried out. Results are shown in Table 12. Also, the coercivities Hc1 and Hc2 of a coated powder regarding each sample were measured. The coercivities were measured using a Hc meter. Results are shown in Table 12.

### Sample Nos. 160, 162, 164, 166, and 168

Dust cores were produced as similar to Sample No. 158 except that the soft magnetic powders formed with coating layers having materials and thicknesses as indicated in Table 12 were used instead of the soft magnetic powder of Sample No. 5. 5Then, evaluations similar to Sample No. 158 were carried out. Results are shown in Table 12. Also, the coercivities Hc1 and Hc2 of coated powders regarding each sample were measured. Results are shown in Table 12.

TABLE 12

| | Soft | | | Ave. | | | | | | | Core loss |
|---|---|---|---|---|---|---|---|---|---|---|---|
| | magnetic | Example/ | | particle | | | | | | | 10 mT, |
| Sample | alloy | Comp. | Composition | size | Coating | Thickness | Coercivity | | | Perme- | 3 MHz |
| No | powder | example | at % | μm | material | nm | Hc1 | Hc2 | Hc2/Hc1 | ability | kW/m3 |
| 157 | 1 | Comparative | Fe91.4Si8.6 | 25 | — | — | 4.5 | 11.2 | 2.49 | 29 | 1980 |
| | | example | | | | | | | | | |
| 158 | 5 | Example | Fe91.4Si8.6 | 25 | | | 4.5 | 8.4 | 1.87 | 32 | 1700 |
| 159 | 1 | Comparative | Fe91.4Si8.6 | 25 | P—Zn—Na—Al—O | 20 | 5.0 | 12.6 | 2.52 | 26 | 1910 |
| | | example | | | | | | | | | |
| 160 | 5 | Example | Fe91.4Si8.6 | 25 | | | 5.1 | 9.7 | 1.90 | 32 | 1640 |
| 161 | 1 | Comparative | Fe91.4Si8.6 | 25 | P—Zn—Na—Al—O | 50 | 5.2 | 12.8 | 2.46 | 24 | 1880 |
| | | example | | | | | | | | | |
| 162 | 5 | Example | Fe91.4Si8.6 | 25 | | | 5.2 | 10.0 | 1.92 | 31 | 1630 |
| 163 | 1 | Comparative | Fe91.4Si8.6 | 25 | P—Zn—Na—Al—O | 100 | 5.4 | 13.0 | 2.41 | 23 | 1860 |
| | | example | | | | | | | | | |
| 164 | 5 | Example | Fe91.4Si8.6 | 25 | | | 5.3 | 10.2 | 1.92 | 30 | 1620 |
| 165 | 1 | Comparative | Fe91.4Si8.6 | 25 | Bi—Zn—B—Si—O | 20 | 5.1 | 12.7 | 2.49 | 26 | 1900 |
| | | example | | | | | | | | | |
| 166 | 5 | Example | Fe91.4Si8.6 | 25 | | | 5.1 | 9.9 | 1.94 | 31 | 1640 |
| 167 | 1 | Comparative | Fe91.4Si8.6 | 25 | Ba—Zn—B—Si—Al—O | 20 | 5.0 | 12.5 | 2.50 | 27 | 1900 |
| | | example | | | | | | | | | |
| 168 | 5 | Example | Fe91.4Si8.6 | 25 | | | 5.1 | 9.8 | 1.92 | 32 | 1650 |

### Evaluation 9

According to the results shown in Table 12, Hc1 slightly increased after coating compared to that of before coating; however, it was confirmed that the powder after coating had maintained the relation of Hc2/Hc1 similar to the case of Sample Nos. 157 and 158 which are samples of before coating. The smaller the ratio Hc2/Hc1, the more preferable it is; and more preferably Hc2/Hc1 was less than 2.0. Also, the permeability was improved, and also it was confirmed that a core loss can be lowered in the case of the dust cores using the soft magnetic metal powders of the examples satisfying the predetermined configurations. Also, in the case of forming the coating layer on the surface of the soft magnetic alloy particle, it was confirmed that the permeability was improved and the core loss was lowered in the case of the dust cores using the soft magnetic metal powders of the examples satisfying the predetermined configurations compared to the dust cores produced using the powders of the comparative examples.

### Sample Nos. 169, 171, 173, and 175

Dust cores were produced as similar to Sample No. 157 except that a powder which was made by mixing the soft magnetic powder Sample No. 1 and an iron powder having an average particle size of 1 μm in a mass ratio as indicated in Table 13 was used. Evaluations were carried out as similar to Sample No. 157. Results are shown in Table 13.

### Sample Nos. 170, 172, 174, and 176

Dust cores were produced as similar to Sample No. 158 except that a powder which was made by mixing the soft magnetic powder Sample No. 5 and an iron powder having an average particle size of 1 μm in a mass ratio as indicated in Table 13 was used. Evaluations were carried as similar to Sample No. 158. Results are shown in Table 13.

TABLE 13

| | Large size powder | | | | | Small size powder | | | | |
|---|---|---|---|---|---|---|---|---|---|---|
| | Soft | | | Ave. | | | Ave. | | | |
| | mangetic | Example/ | | particle | Blending | | particle | Blending | | Core loss |
| Sample | alloy | Comp. | Composition | size | ratio | | size | ratio | | 10 mT, 3 MHz |
| No | powder | example | at % | μm | wt % | Composition | μm | wt % | Permeability | kW/m3 |
| 157 | 1 | Comparative | Fe91.4Si8.6 | 25 | 100 | — | — | 0 | 29 | 1980 |
| | | example | | | | | | | | |
| 158 | 5 | Example | Fe91.4Si8.6 | 25 | | | | | 32 | 1700 |
| 169 | 1 | Comparative | Fe91.4Si8.6 | 25 | 80 | Fe | 1 | 20 | 28 | 1850 |
| | | example | | | | | | | | |
| 170 | 5 | Example | Fe91.4Si8.6 | 25 | | | | | 31 | 1650 |
| 171 | 1 | Comparative | Fe91.4Si8.6 | 25 | 60 | | | 40 | 29 | 1680 |
| | | example | | | | | | | | |
| 172 | 5 | Example | Fe91.4Si8.6 | 25 | | | | | 31 | 1580 |
| 173 | 1 | Comparative | Fe91.4Si8.6 | 25 | 40 | | | 60 | 28 | 1430 |
| | | example | | | | | | | | |
| 174 | 5 | Example | Fe91.4Si8.6 | 25 | | | | | 30 | 1370 |
| 175 | 1 | Comparative | Fe91.4Si8.6 | 25 | 30 | | | 70 | 29 | 1320 |
| | | example | | | | | | | | |
| 176 | 5 | Example | Fe91.4Si8.6 | 25 | | | | | 30 | 1280 |

### Sample Nos. 177, 179, and 181

Dust cores were produced as similar to Sample No. 157 except that a powder which was made by mixing the soft magnetic powder of Sample No. 1, a powder made of Fe—Si−B having an average particle size of 3 μm, and an iron powder having an average particle size of 1 μm in a mass ratio as indicated in Table 14 was used. Evaluations were carried as similar to Sample No. 157. Results are shown in Table 14.

### Sample Nos. 178, 180, and 182

Dust cores were produced as similar to Sample No. 158 except that a powder which was made by mixing the soft magnetic powder of Sample No. 5, a powder made of Fe—Si—B having an average particle size of 3 μm, and an iron powder having an average particle size of 1 μm in a mass ratio as indicated in Table 14 was used. Evaluations were carried as similar to Sample No. 158. Results are shown in Table 14.

TABLE 14

| | Large size powder | | | | | Intermediate size powder | | | Small size powder | | | | Core |
|---|---|---|---|---|---|---|---|---|---|---|---|---|---|
| | Soft | | | Ave | Blend- | | Ave. | Blend- | | Ave. | Blend- | | loss |
| | mangetic | Example/ | Compo- | particle | ing | | particle | ing | | particle | ing | | 10 mT, |
| Sample | alloy | Comp. | sition | size | ratio | Compo- | size | ratio | Compo- | size | ratio | Perme- | 3 MHz |
| No | powder | example | at % | μm | wt % | sition | μm | wt % | sition | μm | wt % | ability | kW/m3 |
| 177 | 1 | Comparative | Fe91.4Si8.6 | 25 | 60 | Fe—Si—B | 3 | 30 | Fe | 1 | 10 | 29 | 1780 |
| | | example | | | | | | | | | | | |
| 178 | 5 | Example | Fe91.4Si8.6 | 25 | | | | | | | | 32 | 1670 |
| 179 | 1 | Comparative | Fe91.4Si8.6 | 25 | 50 | | | 40 | | | 10 | 28 | 1660 |
| | | example | | | | | | | | | | | |
| 180 | 5 | Example | Fe91.4Si8.6 | 25 | | | | | | | | 31 | 1580 |
| 181 | 1 | Comparative | Fe91.4Si8.6 | 25 | 20 | | | 70 | | | 10 | 28 | 1470 |
| 182 | 5 | Example | Fe91.4Si8.6 | 25 | | | | | | | | 30 | 1440 |

### Evaluation 11

From the results shown in Table 13 and Table 14, it was confirmed that even in the case that the dust cores were produced by mixing the soft magnetic powders of the examples and other soft magnetic powders, the permeability was improved; and further to this, in regards with the reduction of core loss, an effect according to the blending ratio of the powders of the examples was confirmed.

### REFERENCE SIGNS LISTS

2 . . . Soft magnetic alloy particle
4 . . . Nitride phase

What is claimed is:

1. A soft magnetic alloy particle comprising Fe and Si:
wherein one to twenty nitride phases are observed in a cross-section of the soft magnetic alloy particle,
an area per each of the nitride phases is within a range of 0.0005 to 10 μm², and
an area ratio of the observed nitride phases occupying the cross-section of the soft magnetic alloy particle is within a range of 0.1 to 2%.

2. The soft magnetic alloy particle according to claim 1 further comprising Co.

3. The soft magnetic alloy particle according to claim 1, wherein at least one of the nitride phases include silicon.

4. The soft magnetic alloy particle according to claim 1, wherein at least one of the nitride phases include 30 atom % or more of nitrogen.

5. A soft magnetic powder including the soft magnetic alloy particle according to claim 1.

6. A soft magnetic powder comprising:
soft magnetic alloy particles comprising Fe and Si,
wherein one to twenty nitride phases per each of the soft magnetic alloy particles in average are observed in cross-sections of the soft magnetic alloy particles,
an area per each of the nitride phases is within a range of 0.0005 to 10 μm² in average, and
an area ratio of the observed nitride phases occupying the cross-section of each of the soft magnetic alloy particles is within a range of 0.1 to 2% in average.

7. A dust core comprising the soft magnetic alloy particle according to claim 1.

8. An electronic component comprising the soft magnetic alloy particle according to claim 1.
